(19) United States
(12) Patent Application Publication
(10) Pub. No.: US 2024/0171591 A1
(43) Pub. Date: May 23, 2024

(54) MANAGEMENT OF DOMAIN NAME SYSTEM REQUEST TRENDS IN A COMPUTING ENVIRONMENT

(71) Applicant: HYAS Infosec Inc., Vancouver (CA)

(72) Inventors: David J. Mitchell, Danville, CA (US); Paul C. van Gool, Santa Barbara, CA (US)

(21) Appl. No.: 17/991,563

(22) Filed: Nov. 21, 2022

(51) Int. Cl. H04L 9/40; H04L 61/4511

(52) U.S. Cl. CPC H04L 63/1408; H04L 61/4511

(57) ABSTRACT

Systems, methods, and software for monitoring deviations from DNS request trends in a computing environment. In one example, a monitoring service identifies baseline information associated with DNS requests in a computing environment based on DNS requests during a baseline period. The monitoring service further monitors DNS request information associated with additional DNS requests in the computing environment and determines when the additional DNS requests satisfy criteria demonstrative of a deviation from the baseline information. Once the criteria are satisfied, the monitoring service performs an action remediate the deviation.

### BACKGROUND

In computing environments, computing devices, both physical and virtual, generate domain name system (DNS) requests or queries that are used to translate a domain name into an IP address. As an example, a user computing device can generate a DNS request that includes a desired domain and communicate the DNS request to a network gateway. In response to receiving the request, the network gateway can forward the request to a DNS server that provides a translation of the desired domain to an IP address. The IP address is provided as a DNS response to the requesting device, permitting the device to communicate with the destination server associated with the IP address.

However, as the number of DNS requests in a computing environment increase, chances of a DNS request attempting to communicate with a malicious destination also increase. Moreover, although firewalls can block traffic to known malicious IP addresses, IP addresses only provide some information about the traffic in the computing environment. Often, malicious, or undesirable destinations can change IP addresses, preventing a firewall from blocking the communication.

### Overview

Provided herein are systems, methods, and software for monitoring and managing permitted domain name system (DNS) requests in a computing environment. In one example, a monitoring service obtains DNS request information associated with one or more computing devices of a first type and identifies one or more trends associated with the DNS request information. The monitoring service further monitors additional DNS request information associated with a computing device of the first type and determines when the additional DNS request information associated with the computing device satisfy one or more criteria demonstrative of a deviation from the one or more trends. In response to determining that the additional DNS request information associated with the computing device satisfies the one or more criteria, the monitoring service performs an action associated with the computing device.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to monitor and control domain name system (DNS) requests for computing devices according to an implementation.

FIG. 2 illustrates an operation of a management service to control DNS requests for computing devices according to an implementation.

FIG. 3 illustrates a timing diagram to manage DNS requests for computing devices according to an implementation.

FIG. 4 illustrates a data structure to manage approved DNS request trends for a computing environment according to an implementation.

FIG. 5 illustrates an operational scenario of identifying an approved DNS configuration for a computing environment according to an implementation.

FIG. 6 illustrates a monitor computing system to manage approved DNS requests for a computing environment according to an implementation.

### DETAILED DESCRIPTION

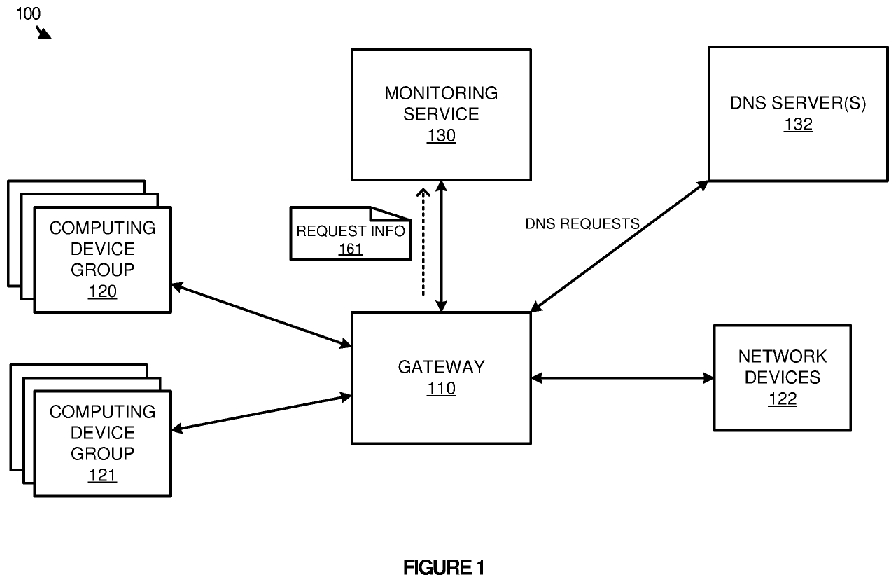

FIG. 1 illustrates a computing environment 100 to monitor and control domain name system (DNS) requests for computing devices according to an implementation. Computing environment 100 includes gateway 110, computing device groups 120-121, network devices 122, monitoring service 132, DNS server(s) 132, and request information 161. Although demonstrated with a single gateway in the example of computing environment 100, a computing environment could employ any number of gateways to support the connectivity of the required computing devices. Each of computing device groups 120-121 can include any number of computing devices, wherein the computing devices can include physical computers (e.g., user devices, servers, and the like) or virtualized endpoints (e.g., virtual machines, containers, and the like). Monitoring service 130 can execute on one or more computing systems, such as servers, desktop computers, or some other computing system. DNS server(s) 132, network devices 122, and gateway 110 can comprise any combination of servers, gateways, or some other computing or gateway device.

In computing environment 100, computing device groups 120 communicate with network devices 122 using gateway 110. Gateway 110 can provide routing, firewall, and other networking operations that permit connections between the computing devices of computing device groups 120-121 and network devices 122. Network devices 122 can comprise servers, user devices, or some other device or service. When a communication is required, a computing device in computing device groups 120-121 can generate a DNS request that includes a desired domain name. The request is communicated from the computing device to gateway 110 that in turn communicates the DNS request to DNS server(s) 132. DNS server(s) 132 can then perform a translation of the domain name to an IP address and provide the IP address to the requesting computing device via gateway 110. Although demonstrated as resolving the DNS request at DNS server(s) 132, gateway 110 can perform a DNS lookup in some examples without requiring an external server.

As the DNS requests are generated from computing device groups 120-121, gateway 110 can provide DNS request information 161 to monitoring service 130. The DNS request information 161 can include the domain names in the requests, the time stamps of the request, the type of computing device making the request, or some other information. Although demonstrated as separate from gateway 110, monitoring service 130 can be implemented wholly or partially on gateway 110. In some examples, each computing device group of computing device groups 120-121 can be assigned by an administrator of computing environment 100. For example, an administrator may define computing device group 120 that corresponds to a first division of an organization, while computing device group 121 can comprise a second division of the organization. Gateway 110 can recognize the device group based on the IP address associated with the request or based on some other information included as part of the DNS request. For example, gateway 110 can recognize that a DNS request originates from a computing device in computing device group 120 based on a source IP address for the DNS request. Although demonstrated with two computing device groups in computing environment 100, a computing environment can employ any number of device groups that are assigned by the administrator.

After providing DNS request information 161 to monitoring service 130, in some implementations, monitoring service 130 identifies baseline information associated with the DNS requests from computing device groups 120-121. The baseline comprises one or more trends that indicate domain names requested from each computing device group of computing device groups 120-121, the frequency of the domain names requested by each computing device group of computing device groups 120-121, commonalities of the DNS requests (e.g., locations of the destination services), or some other information associated with the DNS requests from computing device groups 120-121. The trends can be identified directly from the request information 161 or can be determined at least partially from other resources that can provide records, location information, posture information for the destination device (destination IP address), or some other supplemental information based on request information 161.

In at least one example, the baseline information can represent a period, such as a day, a week, or some other period in association with computing environment 100. The one or more trends can then be extrapolated to a longer period and used to predict future requests in association with computing device groups 120-121. In some examples, the trends are automatically identified by monitoring service 130, however, information about the trends can be provided to an administrator of computing device groups 120-121 and the administrator can approve the baseline prior to being used by monitoring service 130 to identify potential DNS issues or threats associated with the devices of computing device groups 120-121. In some examples, each computing device group can be associated with one or more unique trends, wherein the one or more trends can indicate domain names requested by the computing device group, the frequency of the requests, the timing of the requests, or some other information associated with the requests. Thus, computing device group 120 can be associated with first baseline trends, while computing device group 121 is associated with second baseline trends.

After the trends are identified, gateway 110 continues to provide DNS request information 161 to monitoring service 130. Monitoring service 130 compares the additional DNS request information to the trends to determine when one or more criteria are satisfied indicating a deviation by one or more computing devices in a computing device group from the one or more trends. A deviation can include a request to an unknown domain name or names, a more frequent request to one or more domain names, or some other criteria. In at least one implementation, monitoring service 130 will implement an action in response to the detected deviation, wherein the action can block communications associated with the affect device, generate a report associated with the affected device, provide some other action in association with the deviation.

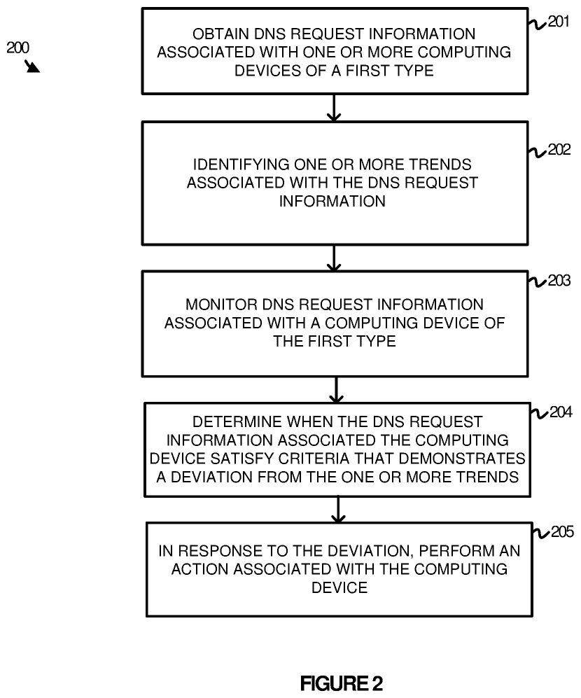

FIG. 2 illustrates an operation 200 of a management service 130 to control DNS requests for computing devices according to an implementation. The steps of operation 200 are referenced parenthetically in the paragraphs that follow with reference to systems and elements of computing environment 100 of FIG. 1.

In operation 200, management service 130 obtains (201) DNS request information associated with one or more computing devices of a first type. For example, as gateway 110 identifies DNS requests, gateway 110 can gather DNS request information that includes the domains associated with the requests, timestamps of the requests, the device types (identified from the source IP address or some other information in the header), or some other DNS request information. From the DNS request information, operation 200 further identifies (202) one or more trends that represent a baseline from the DNS request information. The one or more trends can indicate domains that are requested by the first type of devices, the frequency that the domains are requested, or some other trend associated with the requests. In some implementation, monitoring service may identify supplemental information associated with the domains, including records, registrars, host location, or some other information associated with domain registration. In at least one example, the DNS request information can be sampled during a baseline period, wherein the baseline can be used to define how the computing environment operates during normal operation. The administrator can provide feedback indicating that the operation is normal in some examples by reviewing the identified trends and providing an indication of approval.

After the one or more trends are identified in association with the baseline, operation 200 further monitors (203) additional DNS request information associated with a computing device of the first type. In some examples, computing devices in a computing environment can be assigned to different device groups, which represent different types of devices. For example, devices providing a first operation can be assigned to a first group, while devices providing a second operation can be assigned to a second group. The different operations can represent different divisions in an organization (e.g., sales, legal, etc.), can represent different web applications (e.g., front end, data processing, etc.), or can represent some other different operation. The different types of devices or device groups can be defined by an administrator, wherein IP addresses or other source information in the header of the DNS request can be used to identify the requesting device. The additional DNS request information can indicate the destination URL, the source IP address, the timestamp of the request, or some other information associated with the DNS requests.

As the additional DNS request information is monitored, operation 200 further determines (204) when the DNS request information associated with the computing devices satisfy criteria that demonstrates a deviation from the one or more trends. The deviation may correspond to DNS requests to URLs without similarities to the URLs identified for the one or more trends, more frequent or less frequent requests to domains identified in the trends, or some other deviation from the one or more trends. As an example, devices of a first type can be identified as requesting data from a first domain at a first rate to establish a first trend. However, while monitoring the requests from a device of a first type, monitoring service 130 can determine that the device generates DNS requests with attributes different. The request can correspond to different records, registrars, host locations, or some other information that differs from the original trends associated with the device type.

In response to identifying the deviation, operation 200 further performs (205) an action associated with the computing device. The action can include actions to remediate the issue, such as blocking the device from communications with other devices, limiting the communications associated with the device, stopping one or more applications on the device, or performing some other action. In some examples, the action can include generating a notification for an administrator associated with the device. For example, if a deviation were identified in association with a computing device with computing device group 120, monitoring service 130 can generate a notification for an administrator, permitting the administrator to act on the device. The notification may include information about the deviation, including information about the DNS request, such as the domain, records, location, or other information associated with the request. Additionally, the notification can provide suggestions for actions to be taken in association with the device, including removing the devices connectivity, limiting the devices connectivity, reconfiguring the device, or providing some other suggestion in association with the device.

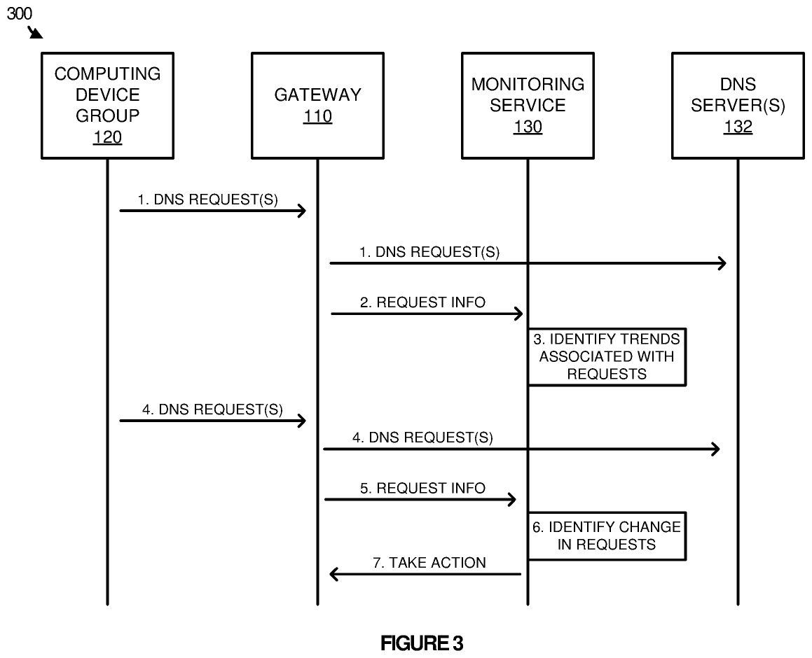

FIG. 3 illustrates a timing diagram 300 to manage DNS requests for computing devices according to an implementation. Timing diagram 300 includes computing device group 120, gateway 110, monitoring service 130, and DNS server(s) 132.

In timing diagram 300, computing device group 120 initiates DNS request(s) that are forwarded to gateway 110 and DNS server(s) 132 at step 1. DNS server(s) 132 respond to the queries with IP addresses, permitting computing device group 120 to initiate communications with destination computing systems. While communicating the first DNS requests, gateway 110 provides DNS request information at step 2 to monitoring service 130. The DNS request information may include domains that were requested, time stamps for when the domains were requested, frequency of requests, returned IP address information, or some other information. Monitoring service 130 can then identify additional DNS request information based on the information provided from gateway 110, wherein the additional information can include records, locations, historical information, posture associated with destination IP addresses, or some other information associated with the DNS requests. For example, for a given DNS request, monitoring service 130 can identify A/AAA records associated with the DNS server, the location of the DNS server, and the posture of the host associated with the destination IP address associated with the domain, or some other information. The information can be maintained locally by monitoring service 130 and/or can be retrieved from external services that can be queried by monitoring service 130.

As the DNS request information is obtained or identified, monitoring service 130 identifies trends associated with the DNS requests at step 3. The trends can correspond to frequency of DNS requests, domains frequently requested, or other similarities and trends associated with the DNS requests from computing device group 120. In at least one implementation, monitoring service 130 identifies a trend when the requests satisfy one or more criteria, such as requests to a domain at a particular frequency. The frequency can be identified as a trend.

After the trends are identified in association with DNS requests from computing device group 120, computing device group 120 can initiate additional DNS requests at step 4. Second DNS request information can then be provided by gateway 110 to monitoring service 130 at step 5, permitting monitoring service 130 to compare the second DNS request information to the trends identified in association with DNS requests from computing device group 120. At step 6, monitoring service 130 can identify a deviation between the second DNS request information and the trends. The deviation can comprise a change in the frequency of DNS requests, a deviation in the domains associated with the requests, a change in the records, location, or other attribute associated with domain name servers, or some other deviation. Thus, even if the domain requests include the same domain for computing device group 120, changes in the records or location can be used to identify a deviation associated with the DNS requests.

Once a deviation is identified, monitoring service 130 initiates an action to respond to the deviation. In some examples, the deviation can correspond to a device deviating from one or more trends identified for computing device group 120. In response to the device deviation, monitoring service 130 can stop or limit connections at gateway 110 by the affected device, can stop connections to the corresponding domain, or can perform some other action in association with the affected device. In some examples, rather than automatically implementing an action, monitoring service 130 can generate a notification for an administrator, wherein the notification can indicate information about the deviation (domain, frequency, location information, and the like), and can further provide one or more remediation action recommendations to a user to respond to the deviation. The recommendations can include monitoring or logging information associated with the affected device (or devices in some examples), can include limiting connections associated with the device, or providing some other recommendation to the administrator. The administrator can select a recommended action, and monitoring service 130 will initiate implementation of the action.

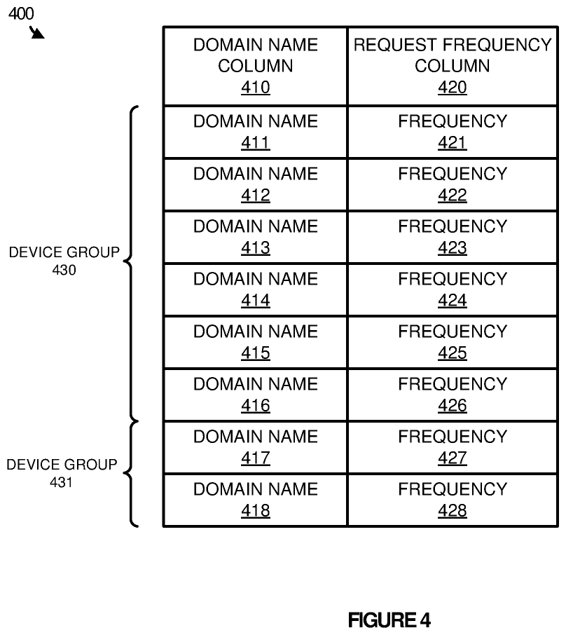

FIG. 4 illustrates a data structure 400 to manage approved DNS request trends for a computing environment according to an implementation. Data structure 400 includes domain name column 410 and request frequency column 420. Domain name column 410 includes domain names 411-418 and request frequency column 420 includes frequencies 421-428. Additionally, data structure 400 further includes device groups 430-431 that are representative of a set of one or more devices in a computing environment. Although demonstrated as a table, the trends associated with a computing environment for DNS requests can be maintained using a linked list, tree, or some other data structure, including combinations thereof.

In deployment, a monitoring service will obtain DNS request information for DNS requests in the computing environment. The request information can include domains or domain names associated with the requests, timestamp information associated with the domains, or some other information associated with the DNS requests in a computing environment. In some examples, the DNS request information can correspond to a test period, wherein DNS requests can be monitored for computing devices in a network for a defined period and trends can be identified during the test period. As the DNS request information is obtained for the monitoring service, the monitoring service can identify trends that are represented as line entries in data structure 400. Each of the line entries includes a domain name and a frequency associated with the domain name.

Here, entries are grouped together into device groups 430-431, wherein each of the device groups can represent one or more computing devices that provide a different service or represent a different organization or segment of an organization. The different services can provide different applications, including server operations or data processing operations, for an organization, or can represent user devices in some examples. The trends can then be compared to second DNS request information for the computing environment to identify when discrepancies occur in relation to the trends.

As an example, the second DNS request information can indicate that a new domain was requested in association with a device for device group 430. In response to the new domain not matching a domain from domain names 411-416, the monitoring service can initiate an action in association with the device and the new domain. In some examples, the monitoring service can perform additional operations to determine whether the newly identified domain is potentially malicious. This can include identifying records associated with the domain, location information associated with the DNS server, posture associated with the end host or some other factor. From the factors, the monitoring service can select an action associated with the domain. If the domain is determined not to be malicious, the monitoring service can take no action or can provide a notification to an administrator indicating the new domain or other information about the request (timestamp, device identifier, and the like). If the domain is determined to be malicious based on the factors, then the monitoring service can take mitigating actions that can include stopping the device from communicating on the network, limiting the communications of the device, or implementing some other action. If the domain is malicious, a notification can also be communicated to an administrator, permitting the administrator to act against the device.

Although demonstrated as identifying a domain name that differed from the trends identified for a device group of device groups 430-431, similar operations can be performed when the frequency of requests differ by a threshold amount. For example, if a device were to request domain name 412 at a frequency that differs from frequency 422 by a threshold amount, then the monitoring service can identify a deviation associated with the device. In response to the deviation, the monitoring service can act against the device. The act can include blocking the device, generating a notification for an administrator, or performing some other action in association with the device.

While demonstrated with two attributes for the trends, the monitoring service may maintain other information associated with the trends for a computing environment. The other information can include location information associated with DNS servers, posture information associated with the destination server or device, certificates for the DNS servers, or some other information.

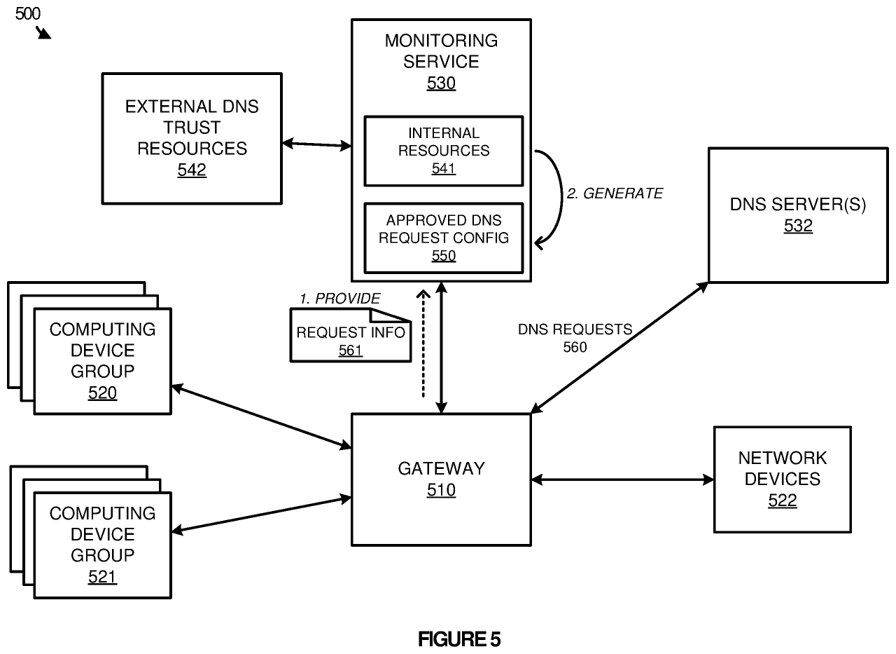

FIG. 5 illustrates an operational scenario 500 of identifying an approved DNS configuration for a computing environment according to an implementation. Operational scenario 500 includes gateway 510, computing device groups 520-521, network devices 522, monitoring service 530, DNS server(s) 532, and external DNS trust resources 542. Monitoring service 530 further includes internal resources 541 and approved DNS request configuration 550, wherein monitoring service receives request information 561 from gateway 510. Although demonstrated as separate from gateway 510, monitoring service 530 can be implemented wholly or partially as part of gateway 510. Further, while demonstrated as obtaining the request information 561 from gateway 510, at least a portion of the information can be provided from the devices in computing device group 520-521.

In operational scenario 500, gateway 510 provides request information 561 to monitoring service 530, wherein request information 561 represents DNS information for a period for computing device groups 520-521. The information can include domains associated with requests, timestamps associated with requests, device identifiers (e.g., source IP addresses) for the requests, or some other information associated with the DNS requests to DNS server(s) 532. In response to receiving request information 561, monitoring service 530 generates approved DNS request configuration 550 that corresponds to approved trends associated with the DNS requests for computing device groups 520-521.

In some implementations, monitoring service 530 uses internal resource 541 and external DNS trust resources 542 to determine the approved DNS request configuration 550. The resources can be used to indicate information about each of the domains, including host location information, records associated with the DNS server, posture for the host, or some other information associated with the DNS request information 561. Similarities or trends can then be identified to identify a baseline for computing device groups 520-521 and applied as approved DNS request configuration 550.

In at least one example, during the period of obtaining request information 561, monitoring service 530 can identify any potentially malicious domains based on the information from resources 541-542. These domains can be identified and removed from approved DNS request configuration 550 in some examples. Alternatively, a notification can be provided to an administrator that permits that the administrator to select or approve potential domains that were identified by monitoring service 530. In some examples, monitoring service 530 can determine when the factors associated with a domain satisfy criteria (e.g., combine for a score) that indicates that domain is potentially malicious. These domains are then flagged for an administrator of the computing environment.

Once approved DNS request configuration 550 is generated, monitoring service 530 can receive additional DNS request information or computing device groups 520-521 and compare the information to the approved configuration. When a deviation is detected that satisfies one or more criteria, monitoring service 530 can act against the deviation. In some examples, monitoring service 530 can continue to use resources 541-542 to determine whether the domains requested are malicious. This can correspond to newly identified domains from the additional DNS request information or can

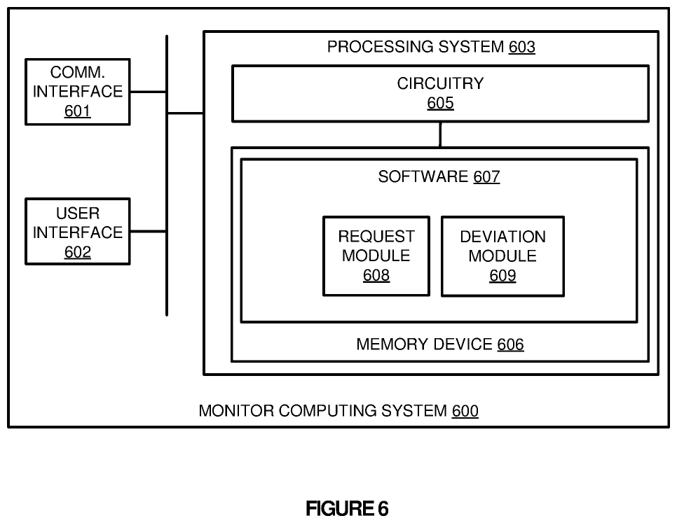

FIG. 6 illustrates a monitor computing system 600 to manage approved DNS requests for a computing environment according to an implementation. Computing system 600 is representative of any computing system or systems with which the various operational architectures, processes, scenarios, and sequences disclosed herein for a firewall may be implemented. Computing system 600 is an example computing system to provide monitoring service 130, although other examples may exist. Computing system 600 comprises communication interface 601, user interface 602, and processing system 603. Processing system 603 is linked to communication interface 601 and user interface 602. Processing system 603 includes processing circuitry 605 and memory device 606 that stores operating software 607. Computing system 600 may include other well-known components such as a battery and enclosure that are not shown for clarity.

Communication interface 601 comprises components that communicate over communication links, such as network cards, ports, radio frequency (RF), processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols, communication signaling, or some other communication format—including combinations thereof. In at least one implementation, communication interface 601 may communicate with at least one gateway of a computing environment or computing devices in the computing environment. Communication interface 601 may further be used to connect with other systems and resources, including servers and client systems.

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples.

Processing circuitry 605 comprises microprocessor and other circuitry that retrieves and executes operating software 607 from memory device 606. Memory device 606 may include volatile and nonvolatile, removable, and non-removable media implemented in any method or technology for storage of information, such as computer readable instructions, data structures, program modules, or other data. Memory device 606 may be implemented as a single storage device but may also be implemented across multiple storage devices or sub-systems. Memory device 606 may comprise additional elements, such as a controller to read operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing circuitry 605 is typically mounted on a circuit board that may also hold memory device 606 and portions of communication interface 601 and user interface 602. Operating software 607 comprises computer programs, firmware, or some other form of machine-readable program instructions. Operating software 607 includes request module 608 and deviation module 609, although any number of software modules may provide a similar operation. Operating software 607 may further include an operating system, utilities, drivers, network interfaces, applications, or some other type of software. When executed by processing circuitry 605, operating software 607 directs processing system 603 to operate computing system 600 as described herein.

In one implementation, request module 608 directs processing system 603 to obtain DNS request information associated with one or more computing devices of a first type. A computing environment or network can be configured with any number of computing device types, including user devices, front-end applications, back-end applications, database management applications, and the like. A user can indicate a type associated with each device, such DNS requests for similar devices can be grouped together. The DNS request information can indicate domains requested, timestamps of the requests, or some other information.

As the DNS request information is obtained, request module 608 directs processing system 603 to identify one or more trends associated with the DNS request information. The trends can correspond to domains requested by the devices of the first type, frequency of the domain requests, locations of the DNS servers, records associated with the DNS servers, or some other information. The trends can be identified directly from the DNS request information or can be identified using other resources, including databases, that can provide information about the DNS requests. The other information can include location information for DNS servers, records, or some other information associated with the DNS requests.

After identifying the one or more trends, deviation module 609 directs processing system 603 to monitor additional DNS request information associated with at least one computing device of the first type and determine when the additional DNS request information satisfies one or more criteria demonstrative of a deviation from the one or more trends. The criteria can include requesting a domain that was not identified in the one or more trends, generating DNS requests to one or more domains at a more frequent or less frequent rate, changes in the information associated with the DNS servers or destination devices (e.g., location or record changes), or some other deviation from the one or more trends. As an example, a device may generate DNS requests at a first rate during a first period that was used to establish a trend but may generate DNS requests at a second rate that far exceeds the first rate during a second period. When the frequency of requests satisfies a threshold, computing system 600 can identify that the device is deviating from the one or more trends.

In response to detecting a deviation associated with at least one device, deviation module 609 directs processing system 603 to perform an action to remediate the deviation. In some examples, deviation module 609 can directly initiate an action on the at least one computing device that deviated from the trends. This can include initiating a configuration of network devices to prevent connections from the affected device, limit connections associated with the affected device, redirect connections of the affected device, provide some other operation in association in association with the affected device or devices deviating from the one or more trends. Alternatively, deviation module 609 can generate a notification that is provided to an administrator of the computing environment that permits the administrator to take an action in association with the deviation. The administrator can select no action, can select any of the actions described above, or can select any other action to respond to the deviation. In some examples, in providing the notification, deviation module 609 can provide one or more action suggestions in addition to information about the deviation. The action suggestions can be based on a variety of factors, including the type of deviation (i.e., the trend that was deviated), the threat level associated with the DNS request(s) that triggered the deviation, or based on some other factor. For example, a deviation associated a new domain in a request can be logged or no action will be suggested by computing system 600 when the supplemental information associated with the domain indicates that the domain is not malicious. The determination can be based on variety of factors, including records associated with the domain, the location of the DNS server, posture information of the destination IP associated with the DNS request, or based on some other factor. In contrast, if a deviation is associated with a DNS that appeared to be malicious based on the supplemental information for the domain, then a recommendation can include limiting one or more connections of the device, performing additional logging, or monitoring of the device, or providing some other similar operation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
obtaining domain name system (DNS) request information associated with one or more computing devices of a first type;
identifying one or more trends associated with the DNS request information;
monitoring additional DNS request information associated with a computing device of the first type;
determining when the additional DNS request information associated with the computing device satisfy one or more criteria demonstrative of a deviation from the one or more trends;
when the additional DNS request information associated with the computing device satisfies the one or more criteria, performing an action associated with the computing device.

2. The method of claim 1, wherein the computing device comprises a physical computing device or a virtual machine.

3. The method of claim 1, wherein identifying the one or more trends associated with the DNS request information comprises identifying domains associated with DNS requests from the one or more computing devices of the first type and identifying frequencies of requests associated with the domains.

4. The method of claim 1, wherein identifying the one or more trends associated with the DNS request information comprises identifying the one or more trends associated with the DNS request information during a trial period.

5. The method of claim 1, wherein performing the action associated with the computing device comprises at least blocking future DNS requests from the computing device.

6. The method of claim 1, wherein performing the action associated with the computing device comprises blocking connections in association with the computing device.

7. The method of claim 1, wherein performing the action associated with the computing device comprises generating a notification for an administrator, wherein the notification indicates at least one domain associated with the deviation and/or a frequency of DNS requests associated with the deviation.

8. The method of claim 7, wherein the notification further comprises a suggested action for mitigating the deviation and wherein the method further comprises:
identify a request to implement the suggested action; and
in response to the request, initiate the suggested action, wherein the suggested action limits one or more connections by the computing device.

9. A computing apparatus comprising:
a storage system;
a processing system operatively coupled to the storage system; and
program instructions stored on the storage system that, when executed by the processing system, direct the computing apparatus to:
obtain domain name system (DNS) request information associated with one or more computing devices of a first type;
identify one or more trends associated with the DNS request information;
monitor additional DNS request information associated with a computing device of the first type;
determine when the additional DNS request information associated with the computing device satisfy one or more criteria demonstrative of a deviation from the one or more trends; and
when the additional DNS request information associated with the computing device satisfies the one or more criteria, perform an action associated with the computing device.

10. The computing apparatus of claim 9, wherein the computing device comprises a physical computing device or a virtual machine.

11. The computing apparatus of claim 9, wherein identifying the one or more trends associated with the DNS request information comprises identifying domains associated with DNS requests from the one or more computing devices of the first type and identifying frequencies of requests associated with the domains.

12. The computing apparatus of claim 9, wherein identifying the one or more trends associated with the DNS request information comprises identifying the one or more trends associated with the DNS request information during a trial period.

13. The computing apparatus of claim 9, wherein performing the action associated with the computing device comprises at least blocking future DNS requests from the computing device.

14. The computing apparatus of claim 9, wherein performing the action associated with the computing device comprises blocking connections in association with the computing device.

15. The computing apparatus of claim 9, wherein performing the action associated with the computing device comprises generating a notification for an administrator, wherein the notification indicates at least one domain associated with the deviation and/or a frequency of DNS requests associated with the deviation.

16. The computing apparatus of claim 15, wherein the notification further comprises a suggested action for mitigating the deviation and wherein the program instructions further direct the computing apparatus to:
identify a request to implement the suggested action;
in response to the request, initiate the suggested action, wherein the suggested action limits one or more connections by the computing device.

17. The computing apparatus of claim 9, wherein the DNS request information further comprises location information for one or more DNS servers for DNS requests from the one or more computing devices and records associated with the one or more DNS servers.

18. An apparatus comprising:
a storage system; and
program instructions stored in the storage system that, when executed by a processing system, direct the processing system to:
obtain domain name system (DNS) request information associated with one or more computing devices of a first type;
identify one or more trends associated with the DNS request information;
monitor additional DNS request information associated with a computing device of the first type;
determine when the additional DNS request information associated with the computing device satisfy one or more criteria demonstrative of a deviation from the one or more trends; and
when the additional DNS request information associated with the computing device satisfies the one or more criteria, perform an action associated with the computing device, wherein the action limits one or more connections for the computing device.

19. The apparatus of claim 18, wherein the computing device comprises a physical computing device or a virtual machine.

20. The apparatus of claim 18, wherein identifying the one or more trends associated with the DNS request information comprises identifying domains associated with DNS requests from the one or more computing devices of the first type and identifying frequencies of requests associated with the domains.
